(19) United States
(12) Patent Application Publication
(10) Pub. No.: US 2017/0098293 A1
(43) Pub. Date: Apr. 6, 2017

(54) SPORTS BOOK EXCHANGE

(71) Applicant: Moluvie Madison, Las Vegas, NV (US)

(72) Inventor: Moluvie Madison, Las Vegas, NV (US)

(21) Appl. No.: 14/876,766

(22) Filed: Oct. 6, 2015

(51) Int. Cl. G06Q 50/34; G06Q 10/08

(52) U.S. Cl. CPC G06Q 50/34; G06Q 10/08

(57) ABSTRACT

A method of trading sports books has the steps of deciding whether to buy and sell, and having decided to buy, selecting a market or a limit order; having selected a market order, purchasing a contract at the lowest ask price, or having selected a limit order, placing an order if the price reaches or goes below the ask price. Having decided to sell, the steps of selecting a market or limit order; having selected a market order, wherein the contract is sold to the highest bid; or having selected a limit order and placing an order if the price reaches or exceeds the bid price. A system for trading sports books is described, having one or more traders, a sports book data center, and a distribution network.

### BACKGROUND OF THE INVENTION

1. Field of Invention

This invention relates to an exchange for sports betting for sports books.

2. Description of Related Art

The most popular form of sports betting, performed through sports books consisting typically of either casinos or online market places, allows customers to bet on the outcome of a game where handicap points are given to the team with the least likely odds to win. So if a bet is made on the team who is most likely to win they must cover the point spread in order for the bet to win, otherwise the win goes to the betters on the other side. To illustrate this we'll examine the 2015 Super Bowl between the Seattle Seahawks and New England Patriots.

The spread opened up at −3 for the Seattle Seahawks meaning that if a bet was placed on them to win they would have to win by more than 3 points. The −3 means 3 points are deducted from the final score before comparing to determine the winner. The New England Patriots would only have to come within 3 points to win, so if Seattle won by only a field goal (3 points) then the New England ticket would still win. Throughout the weeks leading up to the Super Bowl betters favored New England, so the sports books simply adjust the spread, in this case it went to −1 for New England and then ended up back the other way at −1 for Seattle by the start of the game.

The sports books completely control the spread and adjust it to get the most number of betters on each side. The sports book makes money by keeping some of the winnings, usually around 6%. For a $100 bet there would be someone on the Seattle side and someone else on the New England side. The winner would get their $100 back plus $94 (the other side's $100 minus 6%).

Sports books are highly dependent on getting an equal number of betters on each side to minimize their risk so they profit no matter how the game ends.

Therefore there is a need for a sports book exchange to enable a larger audience to participate while the system corrects for supply and demand to maintain fair odds. Additionally, more betting opportunities will be created because a supply and demand exchange market will allow many more spread points to be traded as the spread price will continue to move searching for more trades. Currently the sports books usually locks in a spread for a day or more and they rarely vary much from the initial giving only a couple betting opportunities.

### SUMMARY OF THE INVENTION

A method of trading sports books has the steps of deciding whether to buy and sell, and having decided to buy, selecting a market or a limit order; having selected a market order, purchasing a contract at the lowest ask price, or having selected a limit order, placing an order if the price reaches or goes below the ask price. Having decided to sell, the steps of selecting a market or limit order; having selected a market order, wherein the contract is sold to the highest bid; or having selected a limit order and placing an order if the price reaches or exceeds the bid price.

In an embodiment, if in purchasing the contract a quantity of orders is not fulfilled, the method repeats the step of purchasing a further contract at the lowest ask price. In an embodiment, if in selling the contract the quantity of orders is not fulfilled, the method repeats the step of selling a further contract at a lowest ask price.

The method may have the further steps of comparing a top bid with a top ask price if the bid price is greater than or equal to the ask price, executing the order at the ask price, and setting the price to the last ask price, and if the top bid is less than the ask price, reordering a bid queue in descending bid price and reordering an ask queue in ascending ask price.

A system for trading sports books, is disclosed and has one or more traders configured to place orders and decide whether to buy and sell, and the one or more traders selecting a market or a limit order a sports book data center connected to the one or more traders, the data center configured to purchase a contract at the lowest ask price, the one or more traders having selected a market order, and placing an order if the price reaches or goes below the ask price, the one or more traders having selected a limit order, wherein the contract is sold to the highest bid if the one or more traders selected a market order, and wherein an order is placed if the price reaches or exceeds the bid price if the one or more traders selected a limit order, one or more sports exchange networks and a distribution network connecting the one or more sports exchange networks and the one or more sports book data centers.

The system may have a secondary data center in parallel with the sports book data centers, wherein an order is processed in the secondary system if an order placed time is greater than a system time gap. The orders between the sports book data center and the secondary data center may be separated by the time the order was placed. Near term orders may be processed in the sports book data center and orders over a specified time frame are processed in the secondary system.

The sports book may be configured to place orders received from the one or more traders in bid and ask databases. An order matching and execution algorithm may be executed, and/or a sort bid algorithm and a sort ask algorithm are executed, and wherein a top bid is executed against a bottom ask if the bid is equal to or greater than the ask.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a diagram of the points and spreads of an example game, according to an embodiment of the invention;

FIG. 2 is a flowchart diagram of the sports exchange order execution, according to an embodiment of the invention;

FIG. 3 is a flowchart diagram of the sports exchange order matching and reordering process, according to an embodiment of the invention;

FIG. 4 is a connection diagram of the sports exchange, according to an embodiment of the invention;

FIG. 5 shows a trader's interface for the sports exchange, according to an embodiment of the invention;

FIG. 6 is a quote list of the sports exchange, according to an embodiment of the invention;

FIG. 7 is a functional diagram of the sports exchange, according to an embodiment of the invention;

FIG. 8 shows the secondary systems order system, according to an embodiment of the invention;

FIG. 9 shows an example of system event messages, according to an embodiment of the invention;

FIG. 10 shows an example of game related messages, according to an embodiment of the invention;

FIG. 11 shows an example of game trading messages, according to an embodiment of the invention;

FIG. 12 shows an example of the quote feed, according to an embodiment of the invention;

FIG. 13 shows an example of the bid/ask feed, according to an embodiment of the invention; and

FIG. 14 shows an example of order messages to and from the exchange, according to an embodiment of the invention.

### DETAILED DESCRIPTION OF PREFERRED EMBODIMENTS

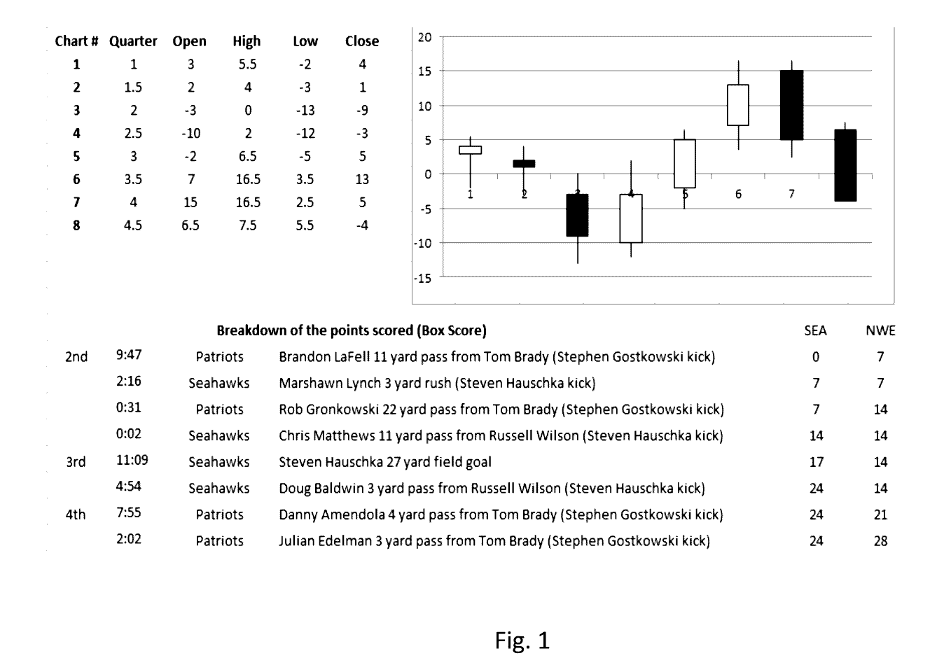

Preferred embodiments of the present invention and their advantages may be understood by referring to FIGS. 1-14 wherein like reference numerals refer to like elements.

The described sports book exchange is a centralized marketplace for betters from many sports books to enter into betting contracts that credit depending on the point spread in a team's favor, or debit depending on the point spread in an opponent's favor. Like stock exchanges, there may be many sports book exchanges, but each is centralized in the sense that is a location for matching many buyers and sellers to create liquidity. Unlike current sports book betting, customers can invest in the point spread outcome of a game and profit/loss depending on the distance in contract spread to the final spread. This primary betting tool is called a Distance Contract.

To illustrate an example of a Distance Contract, FIG. 1 below shows an example of contract pricing for the 2015 NFL Super Bowl. The bottom shows the Box Score breakdown of all the points scored by quarters. The top is a hypothetical data and graph of the Sport Exchange. Each bar represents one half of a quarter and the pricing moves as the spread between the teams change.

In this example, Seattle is in the Long (upwards) direction and New England is Short (downwards) direction. The spread price is a speculative number based on the home team final score minus the away team's final score giving positive numbers for the home leading and negative for the away leading. Since Seattle was considered the favorite this trading opens up at 3 wherein it is expected that Seattle will win by 3 points at the end of the game. Odds makers typically set the line, or initial spread. If a better believes Seattle will win by more they may take a Long position at 3. If another better believes they will not win by 3 or they will lose they can take the opposite side of the contract and Short at 3. Once two betters are matched up the contract trades at that point otherwise the exchange software moves the ticker up or down in the direction of the most outstanding bet orders waiting to be placed.

In this example, if Seattle wins by a touchdown or 7 points then the difference from the opening spread of 3 would be 4 points for the Long and 4 points against the Short. If the two betters from above stayed in their positions then the Long would be credited 4 points minus commissions and the Short debited 4 points.

An example of possible dollar value of points is shown in the chart below that also contains the minimum margin that is held for each contract type.

| Minimum | |
|---|---|
| Margin | Dollar per point |
| $5 | $0.2 |
| $25 | $1 |
| $100 | $4 |
| $1,000 | $40 |
| $2,500 | $100 |
| $10,000 | $400 |

If the betters above were trading the $100 Margin contract the credit/debit would be $4 per point. In this case, the Long position (for Seattle) would be awarded $16 minus a commission for the sports books (divided between the two if there are multiple) and minus a commission for the Sports Exchange. The Short position would lose the $16.

All contracts outstanding at the end of the game are exited at exactly the final score spread without any further bidding price movement.

The Sports Exchange will also offer a Snap Bet contract that is locked into the spread price when it is bought and it is finalized at the end of the game. After the game the winner, who covers their end of the spread, takes the loser's money minus commissions.

In the example above, if a better thought the Patriot's comeback in the second quarter would be short lived they could take a Snap bet at −5 in favor of Seattle. If the final spread of the game is greater than −5 then they would win. Otherwise, if it is less than −5 they will lose. Exactly −5 would be a push and both betters would receive their money back with no commissions paid. If they each took one side of a $100@−5 Snap bet then even though Patriots won the game the final spread stopped at −4 allowing the Seattle better to win $100-commissions.

This contract is very similar to current sports books bets, but the Sports Exchange allows sports books to trade with all sports betters and not just their own customers and place orders for the spread price the better desires.

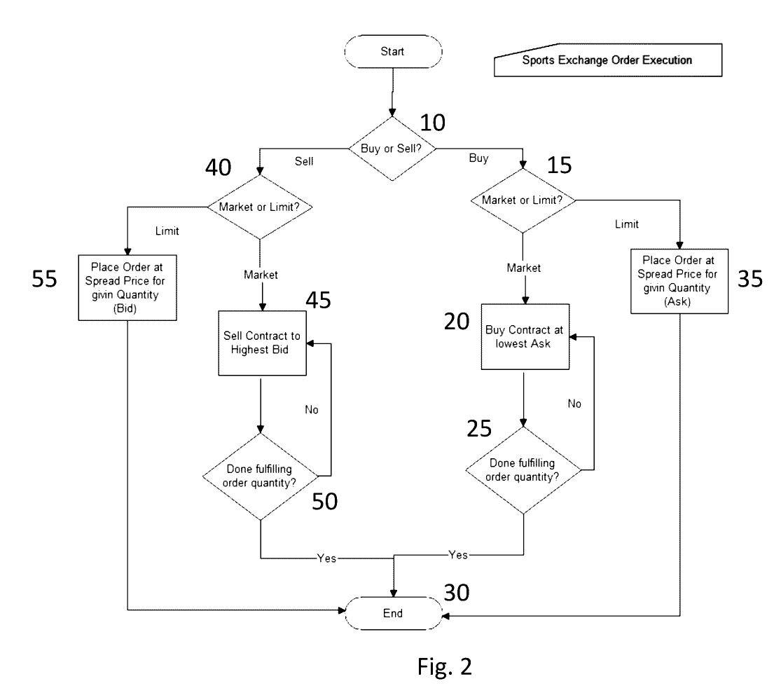

With reference to FIG. 2, in step 10, the participant decides whether to buy or sell a contract. If the participant buys, in step 15 a market or limit order is selected. Market orders simply purchase the contract at whatever rate is available. Limit order only purchase the rate if the price is below a maximum limit price. A market order is selected and in step 20 the contract is purchased at the lowest ask price. In step 25 if the system is not yet done fulfilling quantity then step 20 is repeated and further contracts are purchased at the lowest ask price. Once the system is done fulfilling the contracts then at step 25 the transaction is complete at step 30. If limit order is selected, at step 35 an order is placed if the price reaches or goes below the Ask price.

In step 10, if the participant selects to sell, then a market or limit order is selected in step 40. If a market order is selected, at step 45 the contract is sold to the highest bid. If the system is not done fulfilling the order quantity, then at step 50 it repeats step 45 and sells another contract to the highest bid, until the transaction is complete at step 30. If limit order is selected, at step 55 an order is placed if the price reaches or exceeds the Bid price.

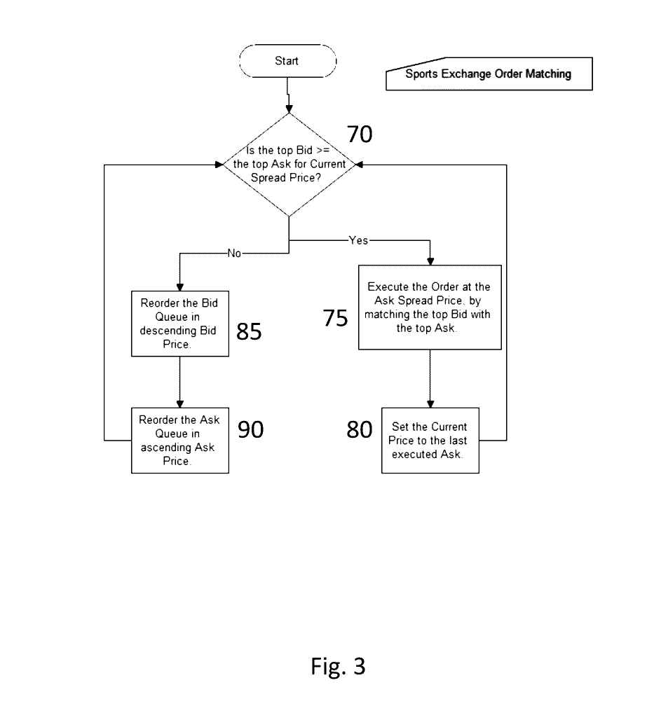

With reference to FIG. 3, the order matching is described. In step 70, the top Bid is compared with the top Ask price to determine a current spread price. If the top Bid is greater than or equal to the Ask, then at step 75 the order is executed at the Ask spread price, by matching the top Bid and top Ask. The current price is then set to the last executed Ask at step 80, and the top Bid is again compared with the top Ask at step 70. If the top Bid is less than the Ask for the current spread price, then at step 85 the Bid queue is reordered in descending Bid price. In step 90, the Ask queue is reordered in ascending Ask price, and the top Bid is compared to the top Ask to generate the current spread price at step 70. In the present system the pricing is based on a spread or a total. For spreads this gives the possibility of a negative spread price. In an embodiment a system provider's commission comes out of the winnings that are similar to sports book betting but different from stock/futures markets where each side pays a commission. The line or initial price is set by odds makers, who understand the supply and demand of the situation that is being bet on. All games wherein the teams are known may be listed and bet upon, with the odds changing due to supply and demand and as the buyers and sellers react to other events, such as the teams' performance in other games, and news such as injuries etc. In an embodiment, positions in the games of a particular sport are open for buying and selling when the season opens.

The Sports Exchange consists of two instruments, Spread and Total. The Spread instrument described in the previous example is finalized to be the home team's final score minus the away team's final score. The Total instrument is finalized to be the home team's final score plus the away team's final score.

For each of the two instruments there are at least three contract types, Distance, Snap and Options. Distance contracts allow a trader to take a long or short position on either the Spread or Total instruments that profit or loss based on the pricing distance from the initial price and the close price; crediting in the same direction and debiting in the opposite direction. The total debit or credit is the point distance from initial to close times the dollar per point of the contracts margin. Snap contracts allow a trader to place a long or short snapshot position at the current price on either the Spread or Total instruments that is held until the game is finalized. At that point, profit and loss is based on whether the price was above or below the snap contract's initial position price, with a long profiting above and debiting below, and a short profiting below and debiting above. In both contracts commissions are taken from the winnings, but it is also possible for instead commissions be taken from each side during the initial purchase. Options are contracts that give the buyer the right, but not the obligation, to buy or sell an underlying asset at a specific price on or before a certain date. Exchanges can offer options in the same way as current stock and futures markets do.

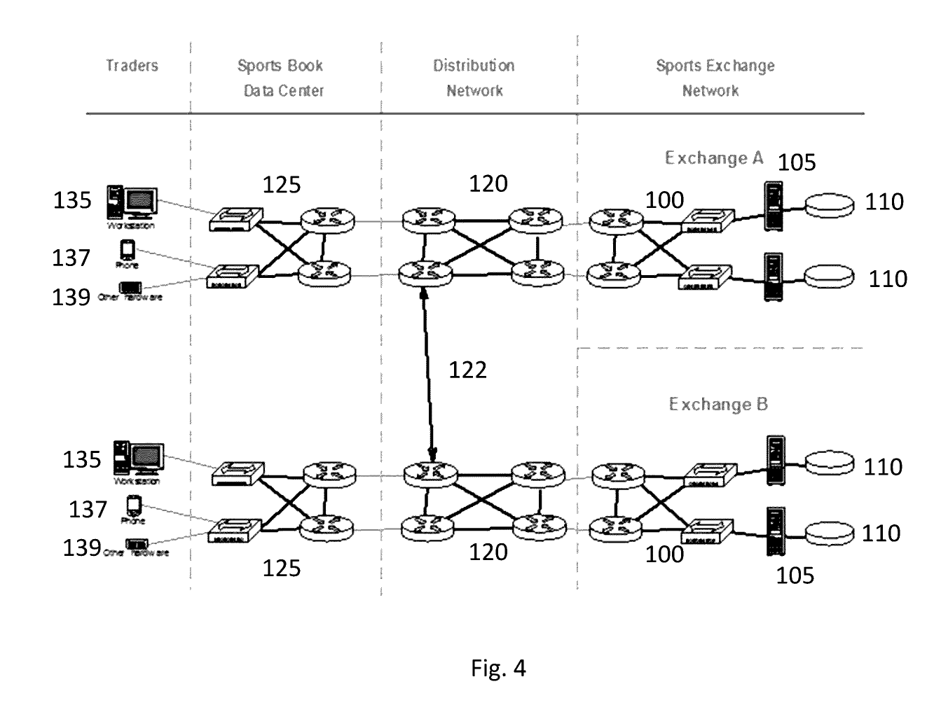

With reference to the sports exchange network diagram FIG. 4, the network for the Sports Exchange consists of the sports exchange network 100 consisting of servers 105 and databases 110 that track orders for the sports books, a distribution network 120 for transmitting the orders within and between exchanges through an inter-exchange link 122, and one or more sports book data centers 125 containing present position data and historical trade data. Traders access 130 is also provided for traders to input orders through workstations 135, mobile devices 137 and other hardware 139.

The distribution network 120 allows sports books and exchanges to communicate with each other in the event that orders move across exchanges (through virtual or physical link 122). If one or more sports books and exchange are owned by a single entity, and the orders move across exchanges, in an embodiment the single entity receives all trading commissions, but on orders that are filled across exchanges the owning entities share the commissions. This allows a much bigger and more liquid trading market including most or all exchanges, while also allowing smaller sports books to tap into larger exchanges' orders. The sports book data center is the customer-facing broker that takes trader's orders and executes them through their exchange's distribution network. An exchange first tries to execute orders within its own exchange to gets a chance at the full commission, if an order is not found there the exchange looks for an order on the distribution network that connects exchanges where the commission will be divided between exchanges. The sports book portion of commission is divided on orders that go across different sports books. The sports books also manage traders' portfolios and customer trading software. Traders are the customers who access the Sports Books through Internet devices to place orders and manage portfolios.

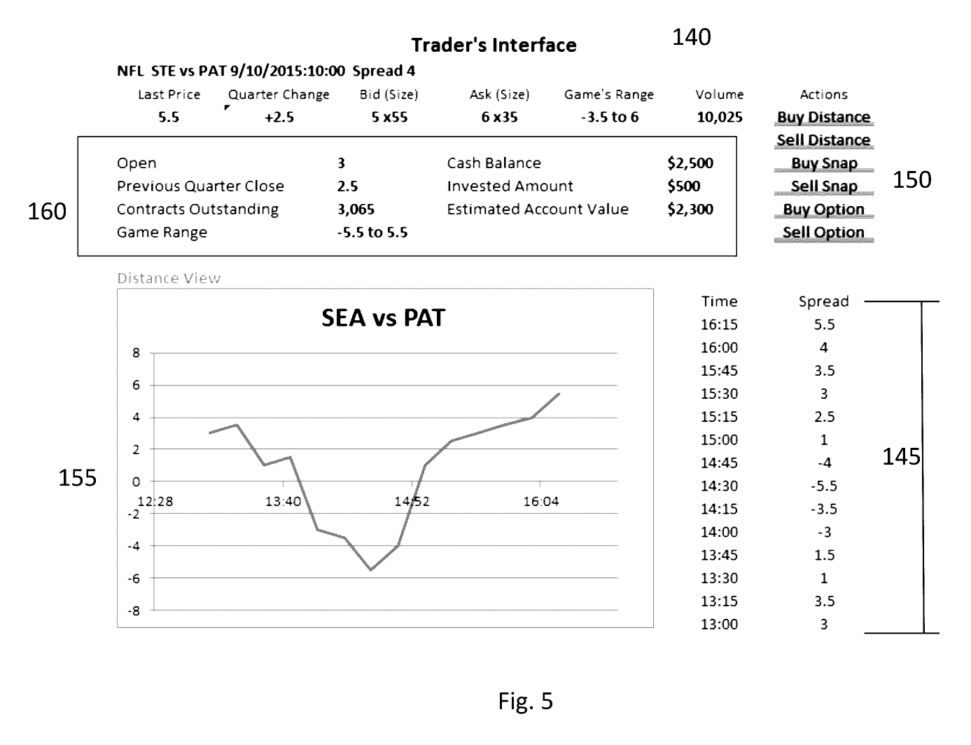

With reference to the trader's interface 140, shown in FIG. 5, it represents a possible single view a trader sees for placing orders. It would contain information on the current trading spread prices 145, an interface to place Buy/Sell Distance, Snap and Options orders 150, a graph of historical trades 155 and other statistical information 160. Sports Books will have their own design and provide additional information they believe to be valuable to their customers.

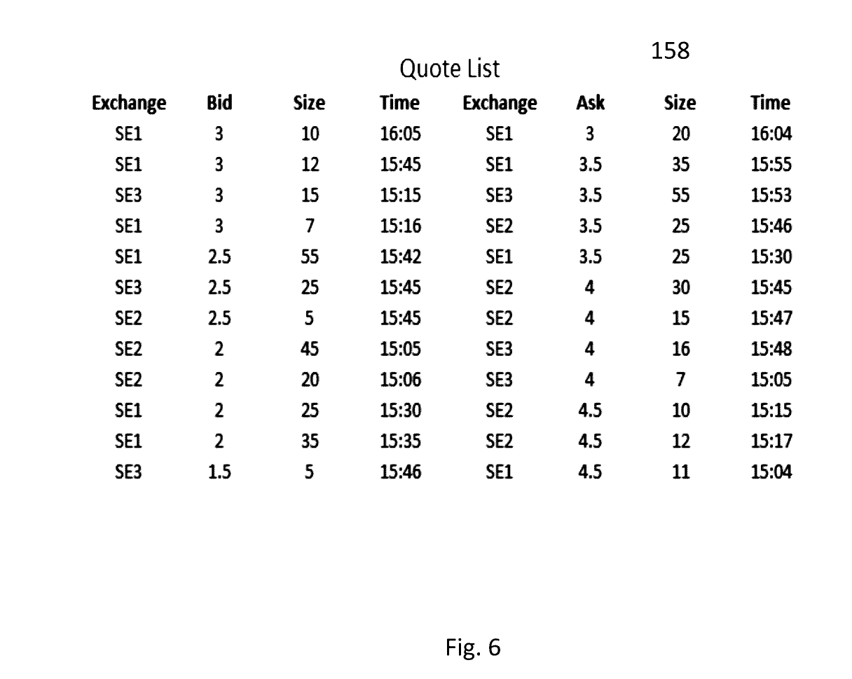

With reference to the quote list 158, shown in FIG. 6, this is a data representation of the Bid and Ask orders that are in the queue to be executed, and may form part of the trader interface 140. The current Bid and Ask are at the top. This additional information may be offered by the exchanges so traders can use it to further investigate trading strategies. These queues will be constantly reordered as new trades are placed and executed.

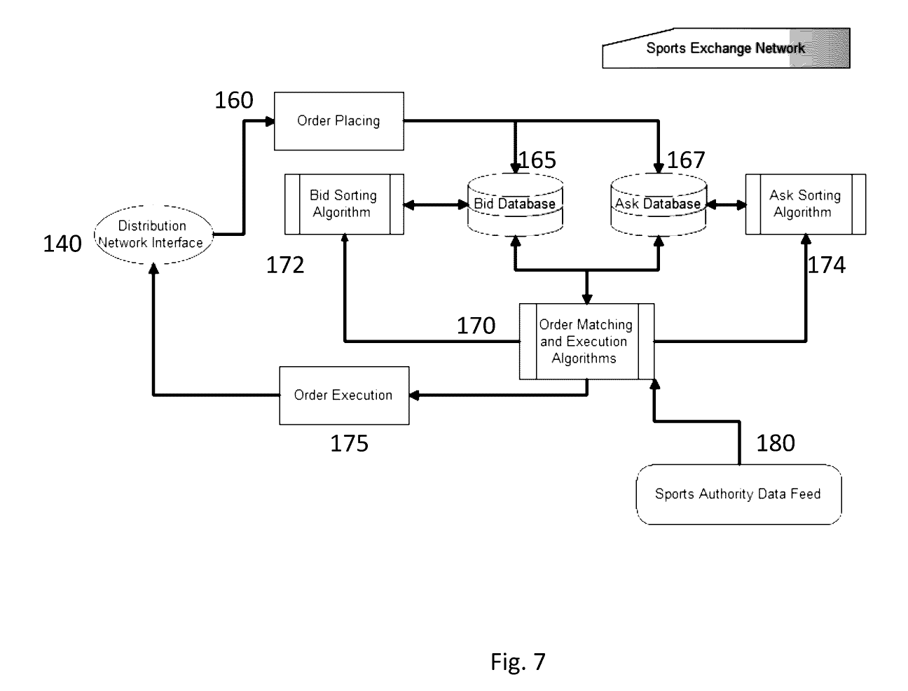

With reference to FIGS. 4 and 7, each of the sports books exchanges may be hosted on servers, running order execution and order matching processing software. The software is an Internet client server application so uses any hardware that accesses the Internet: smart phone, desktop, tablet. It could be possible that custom hardware be made at the sports book's physical locations such as casinos to place the bet, print a ticket and be able to validate that ticket for Snap Bets. This hardware would still access Sports Exchange servers for the latest spread price and order execution.

In step 160, the sports books place orders received from the trader's interface 140 that are mapped to the appropriate Bid Database 165 and Ask Database 167 and receives confirmation and execution messages. The Order Matching and Execution Algorithm are executed in step 170 and call a sort bid algorithm at step 172 and call a sort ask algorithm at step 174, which are described in FIG. 3. In step 175 the top Bid is executed against the bottom Ask if the bid is equal to or greater than the Ask. Further explanations of the Sport Exchange order execution and Sports Exchange order matching are described below. Orders that are executed are sent to their corresponding sports books where they can process and route back messages after order execution to the corresponding sports book. In step 180 the Sports Authority Data Feed provides data, for example final score for home and away, final game end time, game halted or suspended, etc. The exchange needs only data that affect trading such as final outcomes and any conditions that might stop, delay or cancel a game; however they may collect and store additional data. Trades could use more information to base trades on but that is up to the sports books to provide or the traders can obtain it from other sources.

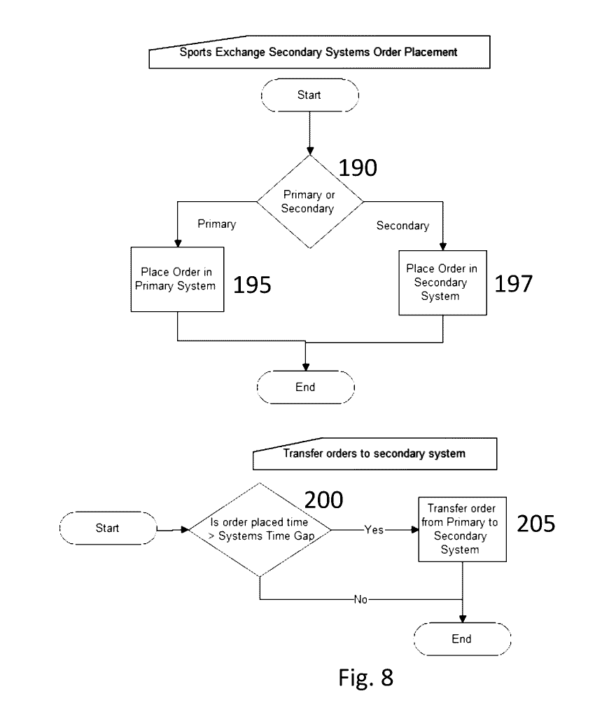

With regard to the secondary system, shown in FIG. 8, additional order matching systems are used to execute orders in parallel and protect against high frequency trading swings. Once an order is being placed, at step 190 it is determined whether is will be processed by the primary or secondary order matching system. If the primary, then at step 195 the order is placed in the primary system. If secondary, at step 197 the order is placed in the secondary system. In step 200, if the order placed time is greater than the systems time gap, then at step 205, the order is transferred from the primary to the secondary system. If not, then the order remains in the primary system. The requirements for using secondary systems are a primary system and at least one secondary system. In this example, the orders between the two systems are separated by the time the order was placed with near term orders in the Primary System and orders over a specified time frame, called the Systems Time Gap, moved to the Secondary System. If orders cannot be executed within the primary system service interval, they may be placed in the secondary system; furthermore, orders may be specified as being processed by the secondary system wherein the order is meant to be delayed by the Systems Time Gap before it is placed. If the System Time Gap is set to 1 minute then orders in the Priority System over 1 minute old would be transferred to the Secondary System. All orders are listed on the Primary System by default unless explicitly specified to be listed on the Secondary System. Orders that target the Secondary System must be delayed by the System Time Gap as all orders must be over 1 min old, in this case. Orders in both systems are transacted simultaneously with each system having its own order matching and execution processing. In an embodiment, separate databases and servers process the transactions in order to efficiently process transactions in parallel. The Priority System will have much greater near term volatility while the Secondary System will often be more stable. Additional systems can be added along with additional Systems Time Gaps, but two will probably suffice for all exchanges.

High frequency trading can seriously affect the short-term price and in the worst cases cause a runaway price in a single direction. Some users may benefit unfairly from such systematic manipulation. The Secondary System helps protect against algorithmic-only price spikes by executing older orders simultaneously without the high frequency trading affecting it, providing a long-term stable execution price. Theoretically, often the Priority System will oscillate around the Secondary System with the short-term volatility staying relatively close to the Secondary System, because at the games end they will both resolve to the final spread or total. In an embodiment the Priority and Secondary Systems reduce trading abnormalities like trading spikes.

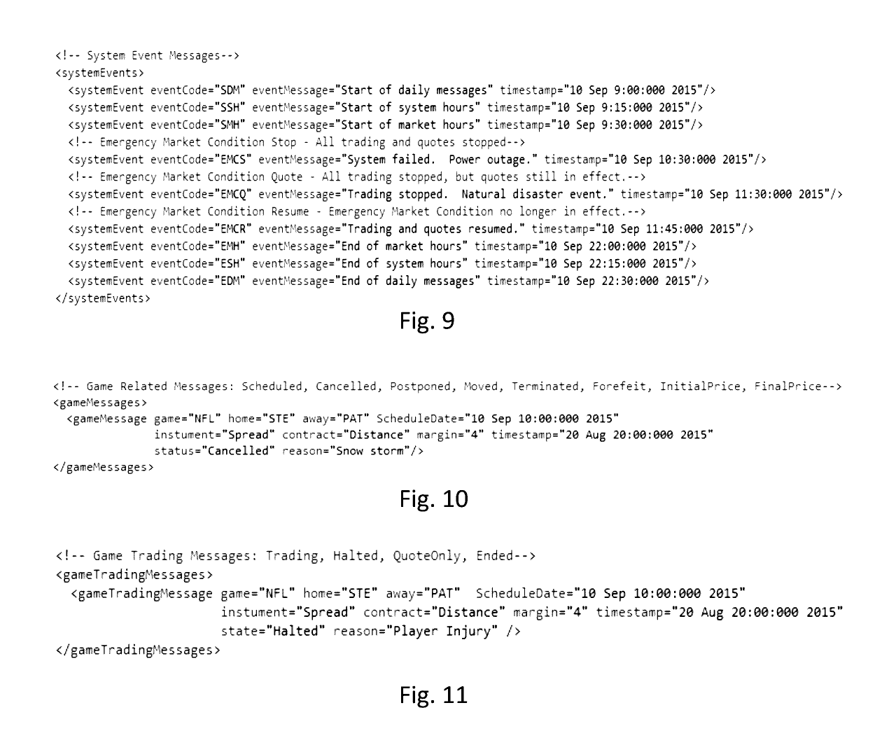

With reference to the Exchange Data Transfer Structures, shown in FIGS. 9-14, data Transfer Structures are shown as XML and indicate the data that is transferred to and from and exchange. Looking first at the system event messages of FIG. 9, these messages are exchange related system events such as the start and stop time of market trading and emergency market conditions. Each message has an Event Code for reference and quick lookup, an event message that details the event to a human reader and a timestamp. The table below lists many of the possible exchange system events.

| Title | Description |
|---|---|
| Start of daily messages | Indicates the system will start sending |
| | messages. |
| Start of system hours | Indicates the system hours has started |
| Start of market hours | Indicates the market hours have started. |
| End of market hours | Indicates the market hours have ended. |
| End of system hours | Indicates the system hours have ended. |
| End of daily messages | Indicates the system messages have |
| | ended. |
| Emergency Market Stop | Indicates that all trading and quotes |
| | stopped. |
| Emergency Market Quote Only | Indicates that all trading has stopped |
| | but quotes still in effect. |
| Emergency Market Resume | Indicates that trading and quotes have |
| | resumed. |

With reference to the common identifier attributes, many messages need to identify the game and contract type. The table below describes these common attributes.

| Attribute Name | Description |
|---|---|
| Game | The game type such as NFL, College Football, NBA |
| Home | The home team's short key. |
| Away | The away team's short key. |
| ScheduleDate | The date the game event will take place. |
| Instrument | The underlying instrument that can be either Spread or |
| | Total. |
| Contract | The contract type that can be Distance, Snap or Option. |
| Margin | The margin of the contract. |
| Timestamp | The timestamp of the generated message. |

With regard to the exemplary game messages shown in FIG. 10, these messages are related to the status of the overall game. They contain the common identifier attributes plus a Status that indicates a game's status such as Started, Ended, Cancelled, and a human descriptive reason. With regard to the exemplary game trading messages of FIG. 11, these messages are related to the trading status of the game. They contain the common identifier attributes plus a State that indicates a game's trading state such as Started, Ended, Halted, and a human descriptive reason.

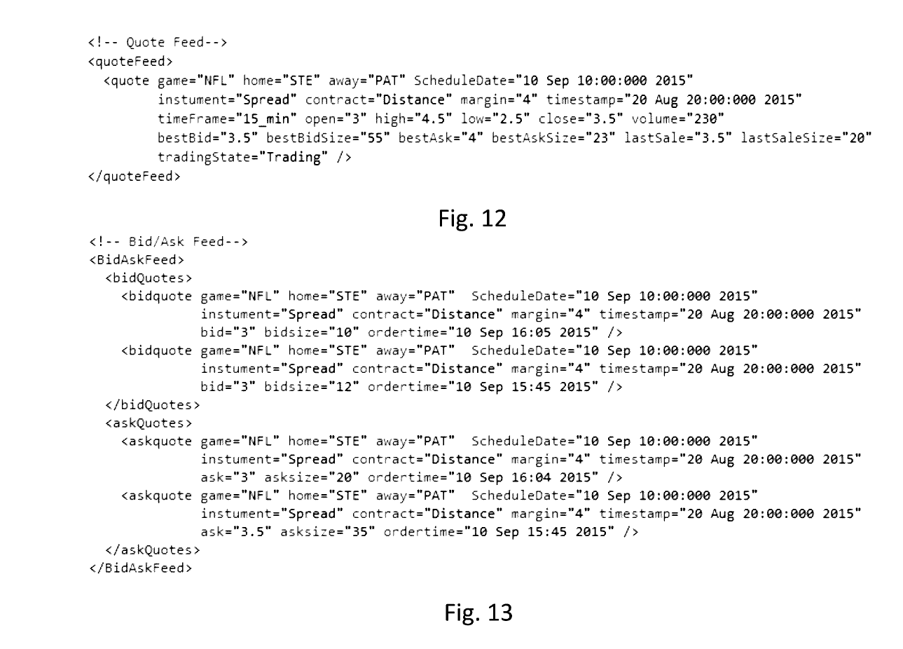

With regard to the quote feed of FIG. 12, these messages are current bid and ask quotes for a particular game. They contain the common identifier attributes plus the attributes defined in the table below.

| Attribute Name | Description |
|---|---|
| Timeframe | The open, high, low, close time frame. Ex: 15_min, |
| | 1_hr, 1_day |
| Open | The opening price of the timeframe. |
| High | The highest price during the timeframe. |
| Low | The lowest price during the timeframe. |
| Close | The closing price of the timeframe. |
| Volume | The trading volume for the timeframe. |
| BestBid | The current bid price. |
| BestBidSize | The current bid size. |
| BestAsk | The current ask price. |
| BestAskSize | The current ask size. |
| LastSale | The last executed price. |
| LastSaleSize | The last sale size. |
| TradingState | The current trading state that matches the possible |
| | states from the game messages. |

With regard to the bid/ask feed shown in FIG. 13, these messages are bid and ask quotes lists for orders for a particular game as described in the Quote List from above. They contain the common identifier attributes plus the attributes defined in the table below.

| Attribute Name | Description |
|---|---|
| Bid | The bid price for the order. |
| BidSize | The bid size for the order. |
| Ask | The ask price for the order. |
| AskSize | The ask size for the order. |
| OrderTime | The time the order was placed. |

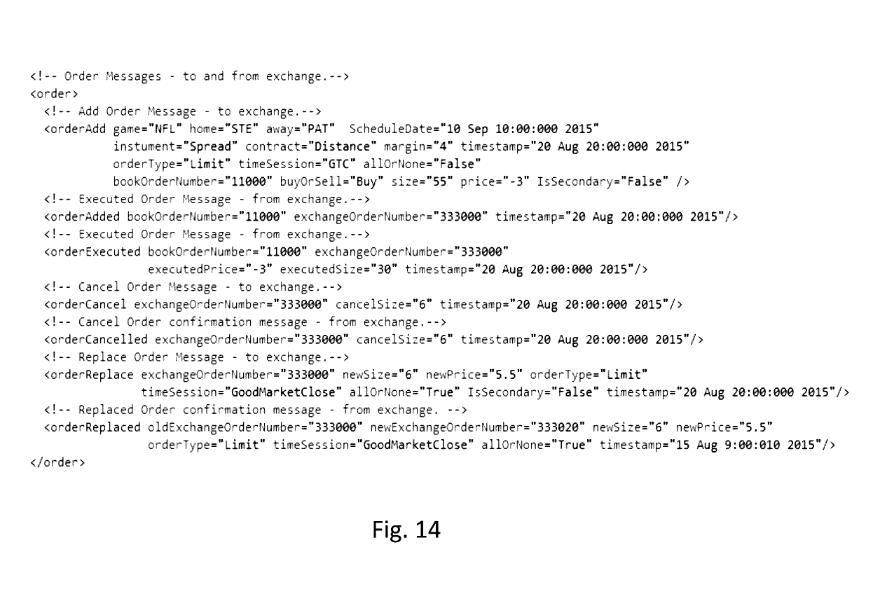

With regard to order messages shown in FIG. 14, these messages are sent to and from the exchange for placing and executing orders. Below are explanations of each and a table that explains all the additional attributes. (Note. Order Add also contains the common attributes.)

OrderAdd—Used to add an order to the exchange.
OrderAdded—a confirmation from the exchange that the order was added with the exchanges order number.
OrderExecuted—a message from the exchange that the order was filled and includes the price and size.
OrderCancel—Used to cancel a previous order placed on the exchange.
OrderCancelled—a confirmation from the exchange that the order was successfully cancelled.
OrderReplace—Used to replace an existing order with a new one.
OrderReplaced—a confirmation from the exchange that the order was replaced.

| Attribute Name | Description |
|---|---|
| OrderType | The type of order. Market for immediate |
| | execution at the current price and Limit |
| | for waiting to execute at a specific price. |
| TimeSession | The time the order should last. GTC for |
| | good until cancelled or Day to only good |
| | until the end of the trading day. |
| | Exchanges can offer additional sessions |
| | if needed such as explicit timeframes. |
| AllOrNone | True to only execute this order if the |
| | exchange can fill the entire size. |
| BookOrderNumber | The order number the sports book is using. |
| BuyOrSell | Indicator for either a Buy or Sell type |
| | order. |
| Size | The size of the order. |
| Price | The desired price for a limit order. |
| IsSecondary | True to place the order on the secondary |
| | system otherwise filled on the primary. |
| ExchangeOrderNumber | The order number the exchange is using. |
| Executed Price | The price the order was filled at. |
| Executed Size | The number of contracts that were filled. |
| CancelSize | The number of contracts to cancel. |
| NewSize | The new number of contracts for new |
| | orders. |
| NewPrice | The new price for new orders. |
| OldExchangeOrderNumber | The old exchange order that was replace. |
| NewExchangeOrderNumber | The new exchange order that resulted from |
| | a replace. |

### Algorithms

Order Matching is continuous matching logic that occurs during live trading sessions. The orders are arranged in Bid (buy orders) and Ask (sell orders) queues contained in database tables or other software data storage. The Bid queue is sorted in descending order and the Ask queue in ascending order by price. A trade occurs when the top Bid price in its queue is greater than or equal to the top Ask price in its queue; or the highest Bid price matched to the lowest Ask price. Orders that meet these criteria are executed at the Ask price and the Stock Exchange current quoted price is adjusted to this price providing continuous moving prices. Matching continues until the highest Bid price is less than the lowest Ask price. At that point both queues are resorted in order to find more matches. The sorting of the queues can be done with any popular sorting algorithm the exchange uses such as Quick Sort, Bubble Sort, Merge Sort, etc. The matching and execution logic is as follows: IF (BID >=ASK) THEN ((1)EXECUTE ORDER at ASK price) ((2)set CURRENT PRICE to ASK price) ELSE ((1)REORDER BID queue) ((2)REORDER ASK queue)−continually repeated in a loop while trading resumes. At the official end of the game all trading executes at the final score calculated as FINAL SPREAD=(HOME TEAM FINAL SCORE−AWAY TEAM FINAL SCORE) for Spread contracts and FINAL TOTAL=(HOME TEAM FINAL SCORE+AWAY TEAM FINAL SCORE) for Total contracts.

Order Placement occurs when the exchange receives an order from a sports book. There are four basic order types: Buy Market, Buy Limit, Sell Market and Sell Limit. Other more advanced order types such as contingency orders, for example, Buy at Market and place a Stop Limit order can be handled by the sports book with the Stop Limit being automatically place upon execution as a quickly followed up second order, if the exchange does not offer this. But most order types will boil down to one of these four types. Both Buy and Sell Limit orders are placed at their price for the given quantity and added to either the Bid or Ask queue described in order matching. The Market orders are sent to order matching and executed as soon as possible against the current Ask that may change during execution especially for large size orders. Market orders are continuously executed against orders at the current price until their entire size is executed. All Or None limit orders are only executed when a batch of one or more orders satisfies the limit price condition and it can be completed in its entirety.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims. U.S.

I claim:

1. A method of trading sports books, comprising the steps of:
a. deciding whether to buy and sell;
b. having decided to buy, selecting a market or a limit order;
c. having selected a market order, purchasing a contract at the lowest ask price;
d. having selected a limit order, placing an order if the price reaches or goes below the ask price;
e. having decided to sell, selecting a market or limit order;
f. having selected a market order, the contract is sold to the highest bid; and
g. having selected a limit order, placing an order if the price reaches or exceeds the bid price.

2. The method of trading sports books of claim 1, further comprising the step of:
a. if in purchasing the contract a quantity of orders is not fulfilled, repeating the step of purchasing a further contract at a lowest ask price.

3. The method of trading sports books of claim 1, further comprising the step of:
a. if in selling the contract the quantity of orders is not fulfilled, repeating the step of selling a further contract at a lowest ask price.

4. The method of trading sports books of claim 1, further comprising the steps of:
a. comparing a top bid with a top ask price;
b. if the bid price is greater than or equal to the ask price, executing the order at the ask price, and setting the price to the last ask price;
c. if the top bid is less than the ask price, reordering a bid queue in descending bid price and reordering an ask queue in ascending ask price.

5. A system for trading sports books, comprising:
a. one or more traders configured to place orders and decide whether to buy and sell, and the one or more traders selecting a market or a limit order;
b. a sports book data center connected to the one or more traders, the data center configured to purchase a contract at the lowest ask price, the one or more traders having selected a market order, and placing an order if the price reaches or goes below the ask price, the one or more traders having selected a limit order, wherein the contract is sold to the highest bid if the one or more traders selected a market order, and wherein an order is placed if the price reaches or exceeds the bid price if the one or more traders selected a limit order;
c. one or more sports exchange networks; and
d. a distribution network connecting the one or more sports exchange networks and the one or more sports book data centers.

6. The system of claim 5 further comprising a secondary data center in parallel with the sports book data centers, wherein an order is processed in the secondary system if an order placed time is greater than a system time gap.

7. The system of claim 6 wherein the orders between the sports book data center and the secondary data center are separated by the time the order was placed.

8. The system of claim 7 wherein near term orders are processed in the sports book data center and orders over a specified time frame are processed in the secondary system.

9. The system of claim 5, wherein the sports book is configured to place orders received from the one or more traders in bid and ask databases.

10. The system of claim 5, wherein an order matching and execution algorithm is executed.

11. The system of claim 5 wherein a sort bid algorithm and a sort ask algorithm are executed, and wherein a top bid is executed against a bottom ask if the bid is equal to or greater than the ask.

12. The system of claim 5 wherein the traders are trading bets on home and away sports teams, and a spread is calculated by the formula:
Spread=Home−Away.

13. The system of claim 5 wherein the traders are trading bets on home and away sports teams, and a total is calculated by the formula:
Total=Home+Away.
